(19) United States
(12) Patent Application Publication
(10) Pub. No.: US 2009/0251070 A1
(43) Pub. Date: Oct. 8, 2009

(54) Electronic Zoom Portable Electric Lamp

(75) Inventors: Paul Petzl, Barraux (FR); Stephane Huguenin, Grenoble (FR); Lionel Ferragut, Grenoble (FR); Jean-Louis Rocourt, Saint Nazaire Les Eymes (FR)

Correspondence Address: OLIFF & BERRIDGE, PLC, P.O. BOX 320850, ALEXANDRIA, VA, 22320-4850, US

(73) Assignee: ZEDEL, Crolles (FR)

(21) Appl. No.: 12/084,647

(22) PCT Filed: Nov. 21, 2006
(86) PCT No.: PCT/FR2006/002555

§ 371 Date: May 7, 2008

(30) Foreign Application Priority Data
Nov. 21, 2005 (FR) 0511783

(51) Int. Cl. H05B 37/02

(52) U.S. Cl. 315/297

(57) ABSTRACT

The portable electric lamp, for example a headlamp, is a lamp with light-emitting diodes comprising at least two distinct light sources (1a, 1b, 1c) having different emission angles. An electronic control circuit controls each of the light sources independently and comprises a distribution control input to select the percentage of the total power supplied to each of the light sources. Control of the distribution can be continuous or by steps. It is preferably combined with a power control input. The distribution control and power control inputs can be formed by two distinct inputs or by a single power and distribution control input. Selection is preferably performed by means of one or two rotary knobs.

### BACKGROUND OF THE INVENTION

The invention relates to a portable electric lamp with light-emitting diodes comprising at least two distinct light sources having different emission angles, an electronic control circuit controlling each of the light sources independently.

### STATE OF THE ART

Portable electric lamps and more particularly headlamps now commonly use light-emitting diodes whose power can be controlled to provide several distinct lighting levels.

Certain headlamps, with double-focus reflector, combine a halogen lamp and light-emitting diodes. The user can thereby choose at any time between long-range lighting (for example about 100 m) by activating the halogen lamp, and close-range lighting using the light-emitting diodes (DUO®LED8 and MYO®5 lamps from Petzl® in particular).

International Patent application WO 2004/070268 further proposes to modify the angle of the light beam emitted by a light-emitting diode lamp by means of a mobile focusing optic lens, which can be moved manually by the user in front of the light-emitting diodes. It is thereby possible, for example with a high-power light-emitting diode, to select a lighting cone corresponding either to short-range wide-beam lighting when the lens is arranged in front of the diode, or to long-range narrow-beam spotlighting when the lens is moved away.

The Lucido® TX1 lamp, which has just been marketed, combines a projector light and a spotlight. For this, it comprises a first light source formed by a long-range light-emitting diode (120 m) or spotlight, and a second light source formed by two light-emitting diodes, whose power can be modified, supplying a diffuse light (projector function with a lighting angle of 40°). The two light sources, controlled by different push-buttons, can be used at the same time if required, the two light-emitting diodes of the second light source then being lit at their maximum lighting power.

Similarly, Patent application US 2003/174499 describes independent control of groups of light-emitting diodes of an array of LEDs.

Patent application US 2005/057929 describes a light-emitting diode lamp in which the intensity of a group of peripheral LEDs can be controlled by means of a knob or an anti-dazzle switch.

### OBJECT OF THE INVENTION

The object of the invention is to provide a portable electric lamp better suited to multi-purpose use.

According to the invention, this object is achieved by the fact that, the total power of the lamp being preset, the control circuit comprises a distribution control input to select the percentage of the total power supplied to each of the light sources.

According to a development of the invention, the control circuit comprises a power control input to select the total power level.

### BRIEF DESCRIPTION OF THE DRAWINGS

Other advantages and features will become more clearly apparent from the following description of particular embodiments of the invention given as non-restrictive examples only and represented in the accompanying drawings, in which:

FIGS. 1 and 2 illustrate the emission angles and directions of light sources of two particular embodiments of a lamp according to the invention.

FIG. 3 schematically represents an embodiment of the electronic circuits of a lamp according to the invention.

FIG. 4 represents an example of a rotary control knob of a lamp according to the invention.

FIGS. 5 and 6 illustrate an example of rotary knobs respectively for the power control and for the distribution control of a lamp according to the invention.

FIG. 7 illustrates the variations of the power distribution between two light sources associated with a distribution control knob according to FIG. 6.

FIGS. 8 to 10 illustrate three particular embodiments of a control circuit of a lamp according to the invention.

FIG. 11 illustrates, for different mean current values, the efficiency variations of a light-emitting diode controlled by a pulse width modulation circuit.

### DESCRIPTION OF PARTICULAR EMBODIMENTS

The portable electric lamp according to the invention is preferably a headlamp. It comprises at least two distinct light sources having different emission angles and constituted by light-emitting diodes. Each light source, which may be inclinable (vertically) and/or of adjustable direction, can be formed by a light-emitting diode or by a diode array.

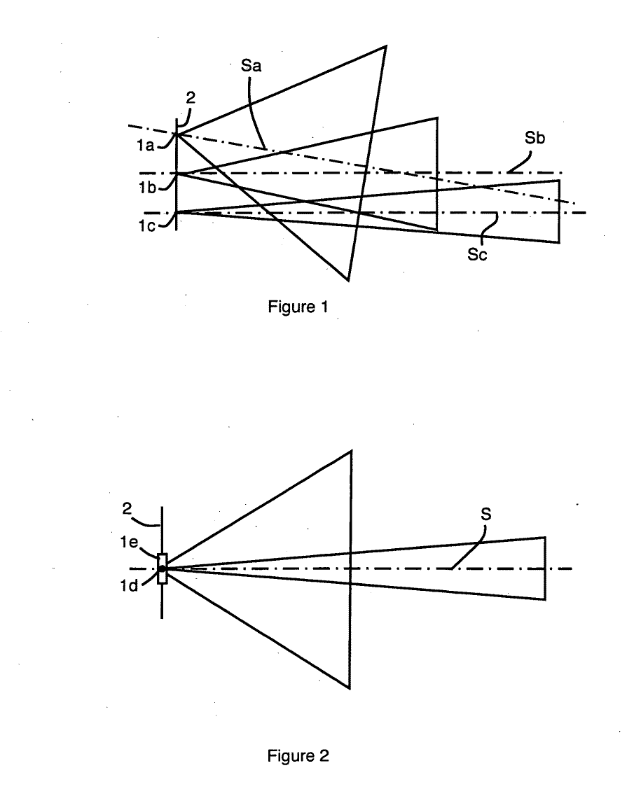

In FIG. 1, the lamp comprises three distinct light sources (1a, 1b and 1c), arranged side by side on the front face 2 of the lamp. The three light sources have three different emission angles. Light source 1a has the largest emission angle (broad beam), for example about 30°, and light source 1c has the smallest emission angle (narrow beam), for example about 8°, whereas the emission angle of light source 1b is of intermediate breadth, for example about 12°. In the particular embodiment illustrated in FIG. 1, the axis Sa of the light beam emitted by light source 1a is moreover inclined with respect to the axes Sb and Sc (parallel to one another) of the light beams respectively emitted by light sources 1b and 1c.

The lamp thus provides a broad light beam, that is preferably also short, when only source 1a is lit, a less broad light beam when only source 1b is lit, and a narrow light beam, which is preferably longer, when only source 1c is lit.

In the embodiment illustrated schematically in FIG. 2, the lamp comprises a central light source 1d and an annular light source 1e, respectively constituted by a central diode or a central diode array and by an annular peripheral diode array. Central light source 1d emits a long and narrow beam, whereas annular light source 1e emits a shorter and broader beam, the two light beams being coaxial, with a same axis S.

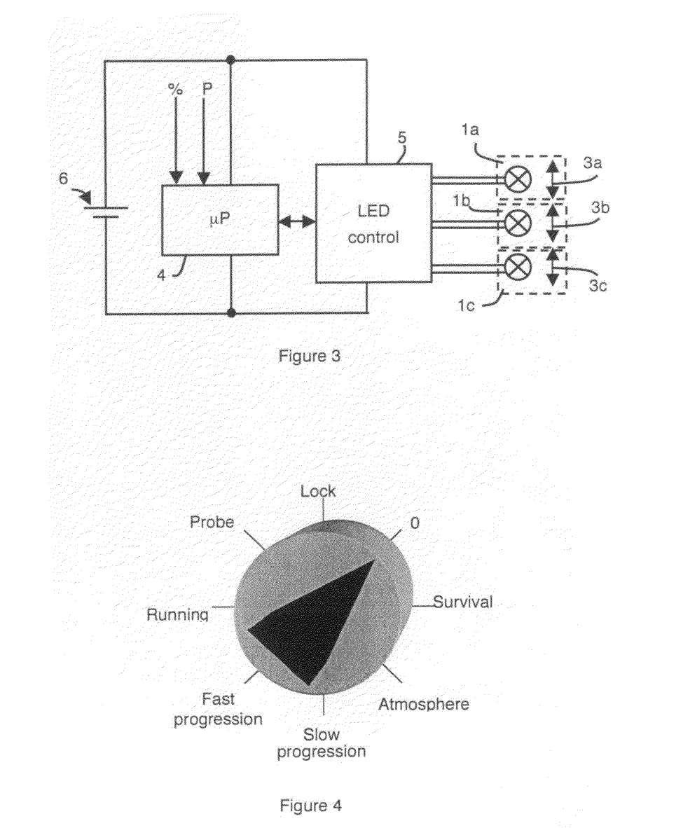

In the particular embodiment of FIG. 3, the lamp comprises three light sources 1a, 1b and 1c respectively formed by a diode or a diode array associated with a fixed optical system 3 (respectively 3a, 3b and 3c), for example formed by a reflector and/or a magnifying glass, defining the emission angle and the range of the corresponding light beam, as well as the axis of the latter.

An electronic control circuit controls each of light sources 1a, 1b and 1c independently. It is for example formed by a microcircuit, typically by a microprocessor 4, connected to a LED control circuit 5. The control circuit (microprocessor 4 and control circuit 5) is supplied by a power source 6, conventionally formed by one or more disposable batteries or by a rechargeable battery.

The control circuit, more particularly microprocessor 4, comprises at least one distribution control input (%) to select the percentage of total power supplied to each of the light sources. Microprocessor 4 takes account of the signals applied on this input to distribute the power between the different light sources. Distributions suitable for different uses of the lamp can thereby be chosen.

As a general rule, the control circuit determines the total power P (power supplied to the lamp, i.e. to the set of light sources) and the distribution thereof between a number N, greater than or equal to 2, of light sources 1i (sources 1a, 1b, 1c . . . 1N) having different emission angles. The distribution is such that the sum Σr1i of the distribution coefficients r1i associated with the different light sources 1i is equal to 1, the power Pi supplied to a light source 1i being given by Pi=P×r1i.

In a first alternative embodiment, the total power remains constant and only the distribution of this power is modified. The control circuit then comprises a single input forming the distribution control input (%). This distribution can vary continuously or discretely. In the latter case, the different possible distributions can be programmed.

In the case of a lamp comprising only the two light sources 1d and 1e, it switches for example from a distribution R1 in which light source 1e receives 100% of the power (r1e=1 and r1d=0), the lamp then providing a broad beam, to a distribution R2 in which light source 1d receives 100% of the power (r1e=0 and r1d=1), the lamp then providing a narrow beam, passing via at least two intermediate distributions, selected for example from the following distributions:
R3: r1e=0.9 and r1d=0.1, i.e. 90% of the total power provided to the light source emitting the broad beam and 10% of the total power provided to the light source emitting the narrow beam.
R4: r1e=0.8 and r1d=0.2.
R5: r1e=r1d=0.5.
R6: r1e=0.2 and r1d=0.8.
R7: r1e=0.1 and r1d=0.9.

In the case of a lamp comprising the three light sources 1a, 1b and 1c, the distribution switches for example from a distribution R′1 in which light source 1a receives 100% of the power (r1a=1, r1b=r1c=0), the lamp then providing a broad beam, to a distribution R′2 in which light source 1c receives 100% of the power (r1c=1, r1a=r1b=0), the lamp then providing a narrow beam, passing via intermediate distributions, selected for example from the following distributions:
R′3: r1a=0.8; r1b=0.2 and r1c=0.

R′4: r1a=0.8; r1b=0 and r1c=0.2.

R′5: r1a=r1b=0.3 and r1c=0.4.

Naturally, numerous other initial conditions and intermediate distributions are possible in the case of a discrete variation.

To enable a better adaptation to different uses of the lamp, the control circuit preferably comprises a power control input to also select the total power level supplied to the lamp.

The distribution control and power control inputs can be formed by a single power and distribution input or by two different inputs respectively referenced % and P in the particular embodiment illustrated in FIG. 3. Selection of the power and of the distribution is then performed by the user by means of a single control means connected to the power and distribution control input in the first case, and by means of two distinct control means respectively connected to the distribution % and power P control inputs in the second case.

In all cases, power control can, like distribution control, be continuous or discrete. In the case of a single control means, the latter can for example be similar to a water mixing faucet, enabling continuous control of both distribution and of total power.

In a particular embodiment illustrated in FIG. 4, the single control means connected to the power and distribution control input is formed by a rotary knob that can take 8 distinct positions associated with different uses of the lamp, as indicated below for a lamp comprising the three light sources 1a, 1b and 1c:
“Lock” position: locking position with lamp off.
“0” position: lamp off.
“Survival” position: distribution R′1 (r1a=1) and total power P=0.2 W.
“Atmosphere” position: distribution R′1 (r1a=1) and total power P=1 W.
“Slow progression” position: distribution R′3 (r1a=0.8 and r1c=0.2) and total power P=1 W.
“Fast progression” position: distribution R′4 (r1b=0.8 and r1c=0.2) and total power P=3 W.
“Running” position: distribution R′5 (r1a=r1b=0.3 and r1c=0.4) and total power P=5 W.
“Probe” position: distribution R′2 (r1c=1) and total power P=5 W.

Of course, numerous other initial conditions and intermediate distributions are possible in the case of a discrete variation.

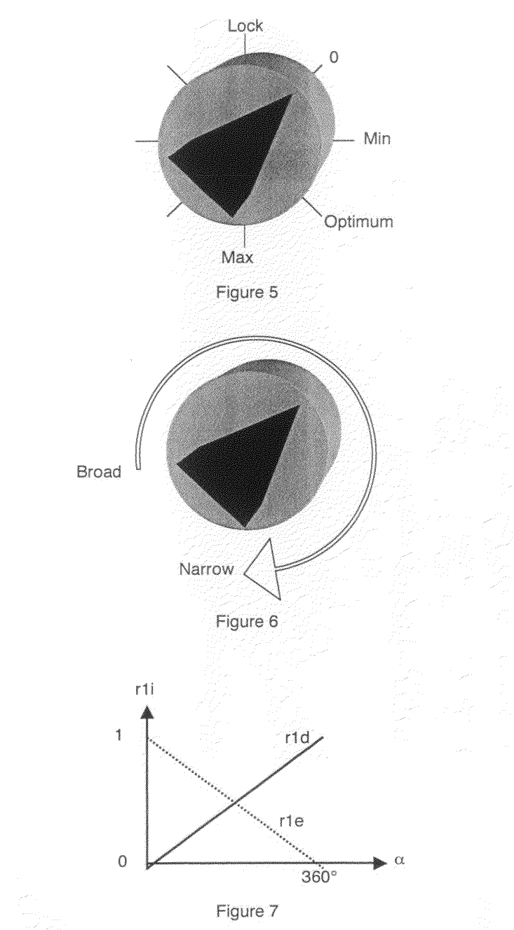

In another embodiment illustrated in FIGS. 3 and 5 to 7, the control circuit comprises a rotary power control knob connected to the power control input, and a rotary distribution control knob connected to the distribution control input. In the alternative embodiment represented, the power control is discrete and the distribution control is continuous. Thus, in FIG. 5, the power control knob comprises the following 5 positions:
“Lock” position: locking position with lamp off.
“0” position: lamp off.
“Min” position: total power P=0.2 W.
“Optimum” position: total power P=1 W
“Max” position: total power P=3 W

For each of the power levels, the user can vary the distribution continuously between a broad beam and a narrow beam. This continuous variation of the distribution according to the angle of rotation α of the knob is illustrated in FIG. 7 for a lamp comprising the two light sources 1d (narrow) and 1e (broad). Whereas the distribution coefficient r1e (broken line) associated with the broad light source 1e goes from 1 to 0 when the angle of rotation α goes from 0 to 360°, the distribution coefficient r1d (unbroken line) associated with the narrow light source 1d goes from 0 to 1.

The progressive variation, either continuous or in steps, of the power distribution between a broad light source and a narrow light source thus enables the user to achieve an electronic zoom effect. Programming of microprocessor 4, in the plant or by the user, can enable different atmospheres suitable for other uses of the lamp to be predefined, for example for close-up work, walking, running, etc.

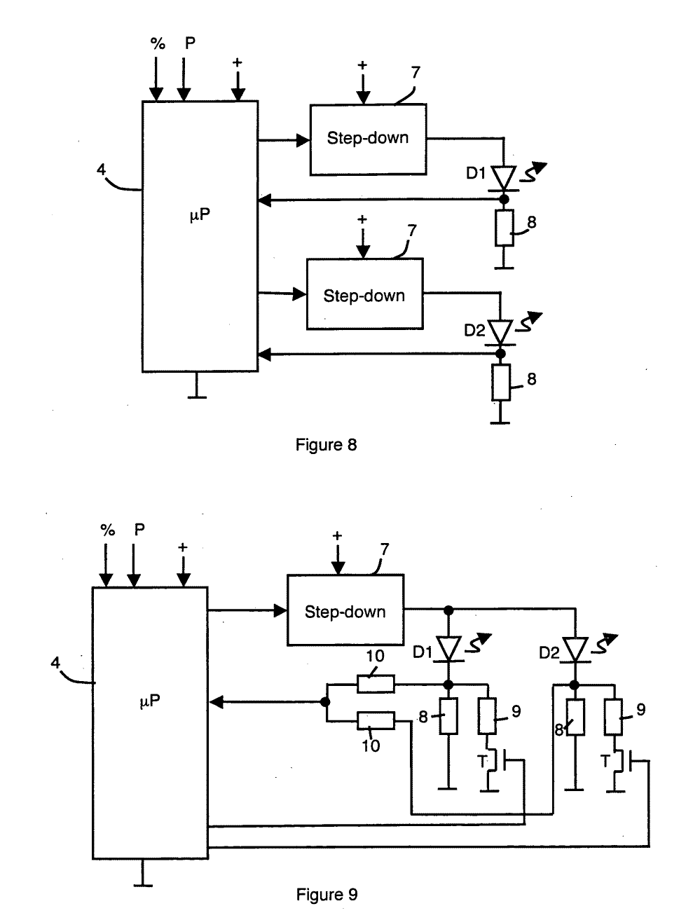

FIGS. 8 to 10 illustrate three particular embodiments of a control circuit enabling independent control of two light-emitting diodes D1 and D2 constituting two light sources having different emission angles.

Regulation of the power supplied to the light-emitting diodes preferably uses one or more converters, for example one or more switched-mode step-down circuits so as to form a chopper circuit. A linear regulation and filtering designed to level out the peak plateaus are also envisageable.

In the embodiment of FIG. 8, an independent step-down circuit 7, preferably of switching type, is associated with each of the diodes. The number of step-down circuits is then equal to the number of light sources of the lamp. The step-down circuit 7 associated with one of the diodes is then connected in series with the light-emitting diode involved and a measuring resistor 8, and comprises a control input connected to an associated output of microprocessor 4. The common point between the diode and the associated measuring resistor 8 is connected to a corresponding measuring input of the microprocessor. The light-emitting diodes are then independently controlled by microprocessor 4 to supply the total power required, distributed as required between the diodes. Such a circuit easily enables more than ten adjustment levels per diode to be obtained.

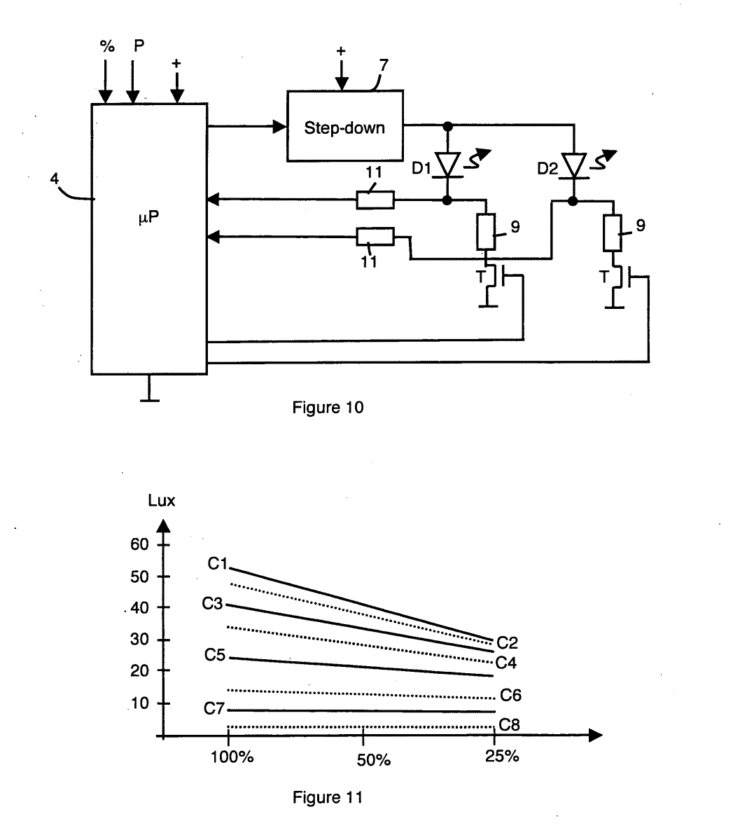

In the embodiments of FIGS. 9 and 10, the control circuit comprises a single step-down circuit 7. For correct operation, light-emitting diodes D1 and D2 then have to have the same characteristics, in particular as far as forward voltage is concerned.

In FIG. 9, diodes D1 and D2 and their associated measuring resistor 8 are connected in parallel to the output of step-down circuit 7. Adjustment of the current in each of diodes D1, D2 is performed by a resistive divider bridge. A series circuit, connected in parallel with the corresponding resistor 8, is for example formed by a resistor 9 and a regulating transistor T. The gate of each of the regulating transistors is connected to a corresponding control output of microprocessor 4. The microprocessor comprises a single measuring input connected by means of two resistors 10 to the common points between the diodes and the associated measuring resistors 8. The number of adjustment levels can be increased by connecting further series circuits (resistor 9 and regulating transistor T) in parallel on each diode. Control does however become more complex.

In FIG. 10, the current adjustment is performed by a low-frequency pulse width modulation (PWM) circuit associated with each diode and controlling the distribution of the total power supplied by step-down circuit 7. Each pulse width modulation circuit comprises a transistor T in series with a resistor 9 and one of the diodes, between the output of step-down circuit 7 and ground. As in FIG. 9, the gate of each of the regulating transistors is connected to a corresponding control output of the microprocessor. Microprocessor 4 comprises 2 independent measuring inputs, respectively connected by resistors 11 to the cathodes of the diodes. The microprocessor thus controls the current flowing in each of the diodes, preferably in synchronized manner to maintain a constant flow. The number of adjustment levels is more than ten for each diode.

In the embodiment of FIG. 10, the total current supplied by step-down circuit 7 is for example 400 mA. To distribute 200 mA on each diode, the two pulse width modulation circuits are at 100%. If one of the pulse width modulation circuits remains at 100%, while the other one goes to a duty factor of 50%, the distribution of the 400 mA is such that the current in the 1^{st} diode is 300 mA and the current in the 2^{nd} diode is 100 mA.

To maintain a constant lighting, this embodiment does however have to take account of a possible drop of the efficiency of a light-emitting diode according to the pulse width modulation. For the same mean power, the efficiency does in fact vary according to the duration of the pulses. FIG. 11 illustrates these variations for different mean current values for a light-emitting diode in a standard 5 mm casing. Curves C1 to C8 respectively represent, from top to bottom, the lighting in Lux versus the duty factor for mean current values of 60 mA (C1), 50 mA (C2), 40 mA (C3), 30 mA (C4), 20 mA (C5), 10 mA (C6), 5 mA (C7) and 1 mA (C8). The efficiency to be taken into account in a circuit according to FIG. 10 is the global efficiency of the two diodes.

The invention is not limited to the particular embodiments described above. In particular, the rotary control knob can be replaced by any other rotary device (rotating ring, knurled wheel of capacitive type . . . ) or by any other control means, for example by a push-button or a sliding button. The different light sources can be associated with different fixed optic systems or with identical optic systems in different positions. Furthermore, the step-down circuits can be replaced by any type of converter circuit, in particular by step-up or mixed step-up/step-down or resistive circuits.

It is thereby in particular possible, in the lamp described above, without any moving mechanical parts, to model the solid light emission angle in the lamp by means of light sources with fixed-focus lenses, by varying the distribution of the intensity in the different light sources.

1. Portable electric lamp with light-emitting diodes comprising at least two distinct light sources having different emission angles, an electronic control circuit controlling each of the light sources independently, wherein the total power of the lamp is preset, the control circuit comprises a distribution control input to select the percentage of the total power supplied to each of the light sources.

2. The lamp according to claim 1, further comprising a control means connected to the distribution control input.

3. The lamp according to claim 2, wherein the control means is formed by a rotary means.

4. The lamp according to claim 3, wherein the rotary means is a continuous control knob enabling continuous progression from a broad beam to a narrow beam.

5. The lamp according to claim 3, wherein the rotary means comprises a predetermined number of distinct positions respectively associated with different distribution ratios of the power between the light sources.

6. The lamp according to claim 1, wherein the control circuit comprises a power control input to select the total power level.

7. The lamp according to claim 6, wherein the distribution control and power control inputs are formed by a single power and distribution control input.

8. The lamp according to claim 6, wherein the distribution control and power control inputs are distinct.

9. The lamp according to claim 8, further comprising a power control means connected to the power control input.

10. The lamp according to claim 9, wherein the power control means is formed by a rotary means.

11. The lamp according to claim 1, wherein at least one of the light sources emits a light beam having an inclinable axis with respect to the axes of the light beams emitted by the other light sources.

12. The lamp according to claim 1, wherein the control circuit comprises at least one converter circuit.

13. The lamp according to claim 12, wherein the control circuit comprises a pulse width modulation circuit associated with each light source and controlling the distribution of the power supplied by the converter circuit.

14. The lamp according to claim 12, wherein the control circuit comprises a distinct converter circuit connected to each light source.

15. The lamp according to claim 1, wherein the light sources are arranged side by side.

16. The lamp according to claim 1, further comprising a central light source and an annular light source, which are coaxial.
